(19) United States
(12) Patent Application Publication
(10) Pub. No.: US 2026/0278762 A1
(43) Pub. Date: Sep. 17, 2026

(54) WIND TURBINE BLADE MANUFACTURING USING INTELLIGENT IMAGING

(71) Applicant: VESTAS WIND SYSTEMS A/S, Aarhus N (DK)

(72) Inventors: Lauris SMUKULIS, Risskov (DK); Paul HARROP, East Cowes (GB); Shaun KENNEDY, East Cowes (GB)

(21) Appl. No.: 19/167,619

(22) PCT Filed: Mar. 18, 2024
(86) PCT No.: PCT/DK2024/050053

§ 371 Date: Sep. 22, 2025

(30) Foreign Application Priority Data
Mar. 23, 2023 (DK) PA202370144

(51) Int. Cl. G06T 7/00; B29C 70/48; B29C 70/54; B29L 31/08; G01N 21/84; G01N 21/88

(52) U.S. Cl. CPC G06T 7/0004; B29C 70/48; B29C 70/54; B29L 2031/085; G01N 2021/8472; G01N 2021/8854; G06T 2207/20084; G06T 2207/30164

(57) ABSTRACT

A manufacturing system for a process of manufacturing a wind turbine blade part, such as a blade half or a segment for a blade half, e.g. a composite fibre wind turbine blade. An imaging system with cameras (CM) arranged at an elevated position to capture images of an area of manufacturing (A_M). A processor system (PS) is arranged to process (IA) captured images from the imaging system to analyze the captured images at least with respect to texture and/or contrast. Based on the image analysis, to detect (AD) an anomaly on a part of the wind turbine blade during the manufacturing process, to classify (ACL) the anomaly as one of a plurality of predetermined types of anomalies according to the analysis of the texture, and to further determine (AL) localization of the classified anomaly on the wind turbine blade, e.g. both span-wise and chord-wise position. A user interface is connected to the processor system to communicate an anomaly type and a localization on the wind turbine blade part in real-time to an operator of the manufacturing process.

### FIELD OF THE INVENTION

The present invention relates to the field of manufacturing of, or parts of wind turbine blades. Especially, the invention provides wind turbine blade manufacturing with use of intelligent imaging for assisting an operator in detecting an error or an anomaly during the manufacturing process.

### BACKGROUND OF THE INVENTION

Manufacturing of large wind turbine blades, such as composite fibre blades, is a complex process involving many activities or states. Due to the large size, e.g. a length of more than 50 m, it is a complex task for an operator to monitor the entire object and to detect any possible error or anomaly at any time during the manufacturing process.

### SUMMARY OF THE INVENTION

Thus, according to the above description, it is an object of the present invention to provide a system and method for wind turbine manufacturing which allows an operator to easily monitor the manufacturing of large wind turbine blades and to allow a fast initialization of an action in case an error is detected during the manufacturing process.

In a first aspect, the invention provides a manufacturing system for a process of manufacturing a wind turbine blade part, such as a blade half or a segment for a blade half, such as a composite fibre wind turbine blade part, the system comprising
an imaging system comprising at least one camera and being arranged to capture images of an area of manufacturing the wind turbine blade part, such as being arranged to capture images covering an entire area of the wind turbine blade part,
a processor system arranged
   to process captured images from the imaging system to analyze the captured images at least with respect to texture and/or contrast,
   to detect an anomaly on a part of the wind turbine blade during the manufacturing process according to the analysis of the texture of the captured images based on an anomaly detection algorithm,
   to classify the anomaly as one of a plurality of predetermined types of anomalies according to the analysis of the texture and/or contrast of the captured images based on an anomaly classification algorithm, and
   to determine a localization of a classified anomaly on the wind turbine blade, at least with respect to a first axis, such as with respect to two axes, and
a user interface operatively connected to the processor system, wherein the user interface is arranged to communicate an anomaly type and/or a localization on the wind turbine blade part of the detected anomaly in real-time to an operator of the manufacturing process.

The analysis of texture and contrast may be performed using image segmentation methods.

By real-time is understood that the communication is performed instantaneously or within the inherent time delays of the processor system. By real-time is also understood, that the information such as anomaly type or localization is communicated e.g. displayed intermittently according to a certain update rate instead of being communicated continuously. The real time operation may further require that some or all of the steps of processing captured images, detection of the anomaly, the classification and the determination of localization is performed within certain time limits such as within the inherent time delay of the processor system. In this way the operator can be informed of possible anomalies during the manufacturing so that corrections can be made as soon as the anomaly has been detected and certainly during the manufacturing instead of waiting until after the manufacturing.

Such system has been found to be a highly efficient tool to ensure error free manufacturing of wind turbine blades, also large blades, e.g. composite fibre blades involving multiple manufacturing steps including layup process, resin infusion etc. The operator can be warned of an anomaly e.g. by a wireless tablet or smart watch, or by other visual and/or audible alarms to catch the operator's attention of an anomaly and its location. It has been found that it is possible to position cameras at an elevated position relative to the manufacturing area, so that they do not interfere with the manufacturing operations and still capture images with enough details to allow for example detection of wrinkles in the layup process.

In preferred embodiments, the image processing and anomaly detection and/or classification steps are trained by feedback from the operator, e.g. the operator can reject an anomaly as “not an anomaly”, “not important”, “yes, important”, or the operator can correct the type of anomaly if not correctly detected. Thereby, the function of the classification and localization of anomalies can be improved.

In preferred embodiments, the images can be analysed to provide an automatic detection of which manufacturing step or stage is currently ongoing. Hereby, the anomaly detection can be improved, since various algorithms or parameters of the same algorithms can be used for anomaly detection and classification in response to the actual detected manufacturing step or stage. For example different anomalies are expected for layup and infusion processes.

For example, the system can be used as a planning tool. The activity tracking or detection of manufacturing steps can be combined with calculating the average duration of different activities from the past numbers of blades and total blade build times to provide a more accurate projections of the upcoming blade production schedule as compared with traditional production plans.

In the following, preferred features and embodiments will be described.

The processor system is preferably arranged to automatically detect a manufacturing activity or manufacturing state in response to an analysis of captured images from the imaging system. Especially, the system may be arranged to automatically detect a current manufacturing activity or manufacturing state based on selecting one of a plurality of predefined manufacturing activities or manufacturing states is the current, such as one of at least 6 predefined manufacturing activities or manufacturing states, such as selecting one of: 1) mould-preparation, 2) gelcoat-application, 3) outer-layup, 4) core-panels, 5) inner-layup, 6) vacuum-bagging, 7) resin infusion, 8) shell-cure-blanket, 9) debagging, 10) inspection-bond-preparation, 11) adhesive-cure, and 12) demould. Especially, the processor system may be arranged to select an anomaly detection algorithm and/or an anomaly classification algorithm in response to a detected manufacturing activity or manufacturing state. Alternatively or additionally, the processor system may be arranged to cause the imaging system to adapt its image capturing with respect to at least one parameter, such as image resolution and/or image capturing frequency, in response to a detected manufacturing activity or manufacturing state. Thus, the by the automatic manufacturing activity or state detection, the image capturing and/or image analysis algorithm behind anomaly detection and classification can be adapted for best performance at the given activity or state in the manufacturing process.

The processor system is preferably arranged to classify an anomaly as one of: 1) a wrinkle in a sheet or ply layup, 2) an aeration or a dry spot in laminate post-infusion, 3) a deviation from a spar cap centerline and adhesive, 4) wrinkles in a vacuum bag and/or foil, 5) air bubbles in a vacuum bag during infusion, 6) positioning deviations from design specifications of components of the wind turbine blade part, such as web locators, webs, lightning protection system cabling and fixtures.

In preferred embodiments, the user interface is arranged to receive a feedback from the operator to a detected anomaly, and wherein the user interface is arranged to communicate the feedback to the processor system. Such feedback may indicate a relevance of the detected anomaly after inspection by the operator, e.g. the operator may provide a feedback as “not relevant”, “relevant”, “highly relevant” or “not an anomaly” in response to an anomaly detected and communicated to the operator by the system. Especially, the processor system is arranged to receive the feedback in response to a detected anomaly and to process the feedback according to a learning algorithm serving to improve an accuracy of the anomaly detection algorithm and/or the anomaly classification algorithm in response to the feedback. Especially, the learning algorithm involves a neural network, such as a convolution neural network and/or a recurring neural network. In this way, the performance of the anomaly detection and classification can be improved when used for a period of time, and further the system can adapt to different changes in the manufacturing setup which can change the visual input to the system.

The processor system may be arranged to determine the localization of the classified anomaly on the wind turbine blade part, with respect to a longitudinal axis along the wind turbine blade part (span-wise), and with respect to an axis perpendicular to the longitudinal axis (chord-wise).

In some embodiments, the user interface comprises a display, such as a display on a portable device such as a tablet or a smart phone or a smart watch, and wherein an anomaly type and a localization on the wind turbine blade part of a detected anomaly is communicated by a symbolic and/or text overlay on a captured photo of the wind turbine blade part. The display may include a large display visible by the operator from many positions. Especially, the system may further be arranged to calculate a value indicative of confidence of a detected anomaly, and this value may also be indicated to the operator on the display.

The system may be arranged to provide a visual and/or audible alarm to the operator when an anomaly has been detected. Hereby, the operator can quickly inspect the anomaly and decide if any action is required.

In some embodiments, the user interface comprises a projection system, such as a laser projector, arranged to provide a visual indication of a detected anomaly on the determined location directly on a surface of the wind turbine blade part. This type of anomaly indication can be a fast way of indicating an anomaly on a large object.

In some embodiments, the user interface is configured to show or indicate localization of a detected anomaly. Especially, the user interface may be arranged to indicate a position along one axis, such as a span-wise axis, where a detected anomaly is located on the blade part.

Especially, the user interface may be arranged to indicate only localization of a detected anomaly.

Especially, the user interface may be arranged to indicate both localization and anomaly type of a detected anomaly.

In some embodiments, the user interface comprises a controllable line of a plurality of visual indicators, such as a plurality of LED light indicators arranged on a line, arranged along the wind turbine blade part to provide a visual indication of a longitudinal location of a detected anomaly. Hereby, the operator can quickly be informed about a detected anomaly and its longitudinal position, and the operator can move to inspect the anomaly. Such line of visual indicators, e.g. lights of different colors, can be used in combination with projection of exact location of anomaly and/or by a display, e.g. on a portable device, as mentioned above. For example, the controllable line of visual indicators may be arranged adjacent to the mould- and thereby along the wind turbine blade part such as in a bar-shaped luminaire extending along the span wise direction of the mould. For example, the controllable line of visual indicators may be arranged above the mould for high visibility.

In some embodiments, the manufacturing system is arranged to perform an automatic resin infusion tracking in response to the captured images during a resin infusion process activity on the wind turbine blade part. This may include performing an edge tracking image analysis to track the resin front in the captured images during the infusion process. By resin infusion is understood the process of arranging a vacuum tight foil over the blade part and fibre plies, followed by supplying infusion resin to the fibre plies under vacuum foil, and further applying a vacuum so that the resin is distributed into the fibre material. Especially, the automatic resin infusion tracking may involve performing an analysis of infusion fill percentage over time during the resin infusion process activity. Especially, the automatic resin infusion tracking may involve communicating via the user interface to the operator, when shell infusion is estimated to have reached 100% or almost 100%. Especially, the processor system is operatively connected to control a resin infusion valve, such as to control the resin infusion valve to close in response to the automatic resin infusion tracking, such as to control the resin infusion valve to close in response to shell infusion being estimated to have reached 100% or almost 100%.

The resin infusion tracking may be based on image analysis wherein coverages of infused areas and non-infused areas are determined to calculate the fill percentage. Additionally or alternatively, the processor system may be arranged to control the resin infusion valve, such as a valve with variable flow control, to control the flow of resin dependent on the fill percentage, e.g. so that the flow is automatically reduced towards zero dependent on the fill percentage.

In an embodiment the manufacturing system is arranged particularly to perform an automatic resin infusion tracking process. According to this embodiment, the processor system is arranged to process captured images to determine the edge tracking based on texture or contrast analysis. One or more of the steps of detecting the anomaly on a part of the wind turbine blade, classification of the anomaly as one of a plurality of predetermined types of anomalies, and determination of a localization of a classified anomaly may optionally not be required. Similarly, the user interface may not be part of the manufacturing system or the user interface may be configured to alternatively or additionally communicate the process of the infusion process, e.g. by displaying the infusion front to the operator.

In the above description the “resin infusion” is used, but it is to be understood that other infusion processes may be used as well, and still the mentioned features of the processor system apply in case of infusing other fluids.

The imaging system may comprise at least one camera positioned and configured to provide images of an entire width of the wind turbine blade part, such as the at least one camera being positioned at a fixed height above a surface of the wind turbine blade part being a factor of 0.8-2.0 times a width of the wind turbine blade part. This has been found suitable for providing a trade between non-disturbance of the manufacturing area and level of details in the images captured with low cost cameras.

Preferably, the imaging system comprises a plurality of cameras positioned and configured to provide images of respective span-wise parts of the wind turbine blade part, e.g. to provide images covering span-wise overlapping areas of the wind turbine blade part.

In a second aspect, the invention provides use of the manufacturing system according to the first aspect for manufacturing a wind turbine blade.

In a third aspect, the invention provides a method of manufacturing a wind turbine blade part, such as a blade half or a segment for a blade half, such as a composite fibre wind turbine blade part, the method comprising
capturing images of an area of manufacturing the wind turbine blade part, such as capturing images covering an entire area of the wind turbine blade part,
analyzing the captured images at least with respect to texture and/or contrast,
detecting an anomaly on a part of the wind turbine blade part during the manufacturing process according to the analysis of the texture of the captured images,
classifying the anomaly as one of a plurality of predetermined types of anomalies according to the analysis of the texture and/or contrast of the captured images, and
determining a localization of a classified anomaly on the wind turbine blade part, at least with respect to a first axis, such as with respect to two axes, and
communicating an anomaly and a localization on the wind turbine blade part of a detected anomaly in real-time to an operator of the manufacturing process.

The method may comprising initiating an action in the manufacturing process to remedy the detected anomaly, e.g. an action initiated automatically by the system e.g. to stop an ongoing process, or an action initiated by the operator.

The method may further comprise receiving a feedback to the processor system from the operator in response to the communicated anomaly. Especially, the method may further comprise training a neural network involved in at least detecting or classifying the anomaly in response to the feedback from the operator.

The method may further comprise detecting a manufacturing activity or manufacturing state in response to an analysis of the captured images.

In a fourth aspect, the invention provides a method of manufacturing a wind turbine blade, the method comprising the steps of the method according to the third aspect.

In a fifth aspect, the invention provides a wind turbine rotor blade manufactured according to the method of the fourth aspect.

In a sixth aspect, the invention provides a wind turbine comprising at least one rotor blade, such as comprising three rotor blades, according to the fifth aspect.

Especially, the wind turbine blades may be arranged to drive an electric generator located inside a nacelle arranged on top of a tower. Especially, the wind turbine may generate an electric power of at least 1 MW, such as 2-10 MW, or more than 10 MW.

In a seventh aspect, the invention provides a manufacturing system for a process of manufacturing a wind turbine blade part, such as a blade half or a segment for a blade half, such as a composite fibre wind turbine blade part, the system comprising
an imaging system comprising at least one camera and being arranged to capture images of an area of manufacturing the wind turbine blade part, such as being arranged to capture images covering an entire area of the wind turbine blade part,
a processor system arranged
   to process captured images from the imaging system to analyze the captured images, such as to analyze captured images at least with respect to edge detection, and
   to perform an automatic infusion tracking in response to the analysis of the captured images during a resin infusion process activity on the wind turbine blade part, such as by performing a resin front tracking by edge tracking in response to the captured images during the infusion process.

Especially, the automatic resin infusion tracking may involve performing an analysis of infusion fill percentage over time during the resin infusion process activity. Especially, the automatic resin infusion tracking may involve communicating via the user interface to the operator, when shell infusion is estimated to have reached 100% or almost 100%. Especially, the processor system may be operatively connected to control a resin infusion valve, such as to control the resin infusion valve to close in response to the automatic resin infusion tracking, such as to control the resin infusion valve to close when shell infusion is estimated to have reached 100% or almost 100%.

In the above description the “resin infusion” is used, but it is to be understood that other infusion processes may be used as well, and still the mentioned features of the processor system apply in case of infusing other fluids.

It is to be understood that the same advantages and preferred embodiments and features described for the first aspect apply as well for the second aspect, and the aspects may be mixed in any way.

### BRIEF DESCRIPTION OF THE FIGURES

The invention will now be described in more detail with regard to the accompanying figures of which

FIGS. 1a and 1b illustrate sketches of a wind turbine blade manufacturing setup with cameras installed to capture images of an entire manufacturing area,

FIGS. 2a and 2b illustrate block diagrams of two different system configuration embodiments,

FIG. 3 illustrates a sketch of elements of a system embodiment,

FIG. 4 illustrates an example of a photo of a wind turbine blade during a layup process where a wrinkle has been detected and its location is communicated to an operator,

FIG. 5 illustrates an example of a user interface comprising a line of light sources arranged span-wise along the wind turbine blade to indicate location of anomalies to the operator, and

FIG. 6 illustrates steps of a method embodiment.

The figures illustrate specific ways of implementing the present invention and are not to be construed as being limiting to other possible embodiments falling within the scope of the attached claim set.

### DETAILED DESCRIPTION OF THE INVENTION

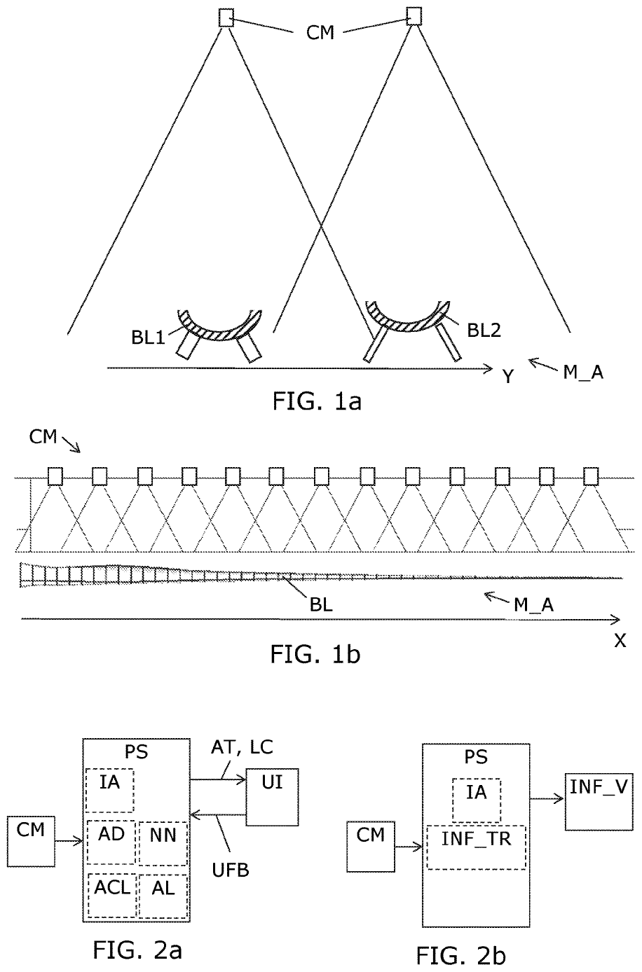

FIG. 1a illustrates a section sketch of a manufacturing area M_A where two wind turbine blade half parts BL1, BL2 are being manufactured. The blade half parts are manufactured in blade moulds (not shown) for example by a Vacuum Assisted Resin Transfer Molding (VARTM) process wherein initially plies of fibre material are laid up in the mould. A vision system comprising cameras CM are arranged at an elevated position above the blade parts BL1, BL2. The two lines from each camera CM indicate image cover area, and as seen the left camera CM can capture images fully covering the left blade part BL1 chord-wise, i.e. along axis Y, while the right camera CM can capture images fully covering the right blade part BL2 chord-wise.

FIG. 1b illustrates a section sketch of a manufacturing area M_A where a blade part BL is seen span-wise, i.e. along axis X. Here, it is seen that a line of cameras CM serve to cover the entire blade part BL span-wise, and as indicated by the two lines from each camera CM, it is seen that the entire span-wise blade part BL is covered with overlapping images from the cameras CM.

With the camera setup shown in FIGS. 1a and 1b, the vision system fully covers the manufacturing area M_A of the blade parts BL, BL1, BL2.

FIG. 2a shows a block diagram of a system embodiment. A vision system comprising a camera CM provides images captured to a processor system PS. The processor system is programmed to execute an image analysis algorithm IA which preferably comprises analyses of the captured images with respect to texture and contrast, e.g. with each image analysed separately in a plurality of segments. The image analysis results are applied to an anomaly detection algorithm AD, an anomaly classification algorithm ACL, and an anomaly localization algorithm AL. The function of these algorithms AD, ACL, AL are to determine if one of a number of predetermined types of anomalies are present, based on the input from the image analysis IA.

If an anomaly is detected, its type and location on the blade part is determined, and the anomaly type AT and location LC are then communicated to a user interface UI, thereby informing an operator of an anomaly which allows the operator to go and inspect the anomaly and initiate an action accordingly, if necessary to remedy the anomaly.

The operator can via the user interface UI provide a feedback UFB on the communicated anomaly AT, LC. The operator may indicated if the anomaly is at all correctly detected, and also the operator may rank the anomaly with respect to relevance or the like, thereby providing the processor system PS with feedback to be applied to a neural network based learning algorithm NN. This learning algorithm NN can increase performance of at least the algorithms AD, ACL over time, and allows adaptation of the anomaly detection and classification to various changes in the physical manufacturing setup.

The user interface UI can be implemented with one or more of: a smart watch, a tablet, a large display, a warning light, an acoustic alarm, a line of lights to indicate anomaly location, a projection system visually indicating the anomaly on the surface of the wind turbine blade part. In case of a smart watch, a tablet or a large display, the display may be used to indicate a photo showing the entire blade part or only part of the blade part indicating the anomaly with graphics and optionally with text indicating the type of anomaly.

Based on the captured images, the processor system PS may be capable of determining the actual manufacturing activity or state. This allows the system to adapt various parameters, e.g. to monitor for specific anomalies related to specific manufacturing activities or states, thus specific algorithms can be selected in response to the determined manufacturing activity or state. Further, the resolution, an optical lens or a frame rate of images captured by the camera CM can be selected specifically for each manufacturing activity or step to provide the best possible performance of the anomaly detection and classification.

FIG. 2b shows another system embodiment which provides a monitoring functionality related to the blade manufacturing step or activity of resin infusion. This embodiment can be combined with the embodiment of FIG. 2a, or it can stand alone.

A vision system comprising a camera CM provides images captured to a processor system PS. The processor system is programmed to execute an image analysis algorithm IA which preferably comprises analyses of the captured images with respect to at least edge tracking or edge detection. The image analysis results are applied to a resin infusion tracking algorithm INF_TR which determines which fraction of the resin infusion process which has been completed, e.g. indicating via a user interface a percentage of the resin infusion which is completed, thus informing an operator of the progress of the resin infusion. In this embodiment, the output of the infusion tracking algorithm INF_TR is used to control the function of an infusion valve INF_V, i.e. to open or close the infusion valve INF_V which control the application of resin during the infusion process. In this way, an automated infusion process can be provided, since the system can identify via edge tracking when the infusion process approaches 100%, and thus when to control the infusion valve INF_V to close.

Further, the infusion tracking INF_TR algorithm may further be able to identify a dry spots, a bubble or other anomalies during the infusion process and to inform the operator accordingly.

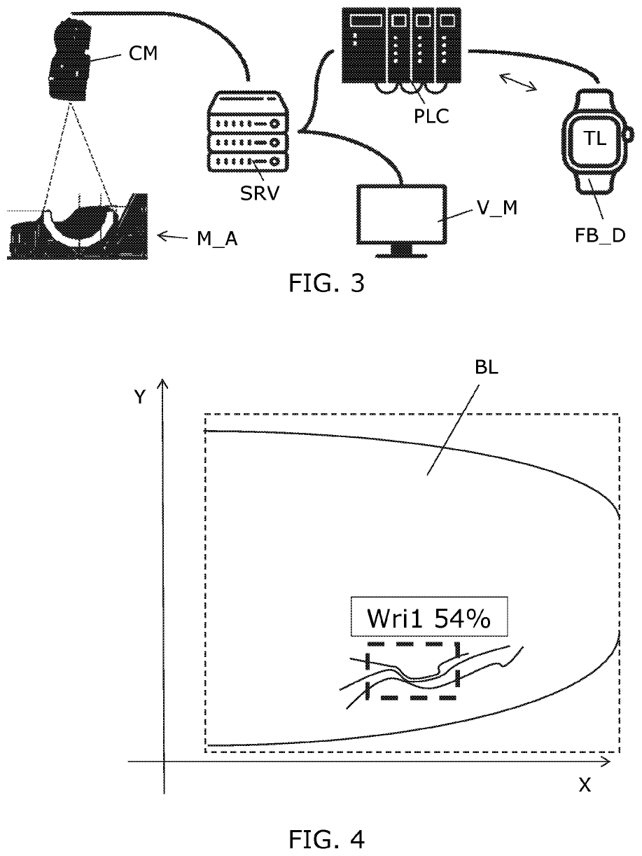

FIG. 3 shows a sketch of possible elements of a system. A camera CM, or an array of cameras, serve to cover a manufacturing area M_A where a wind turbine blade part is being manufactured. Each camera CM may have an optical lens, e.g. a controllable optical lens. The camera CM is connected to a server SRV which performs image processing to detect and classify and localize an anomaly. A user interface is here indicated as a visual monitor V_M, as well as a feedback path here indicated as a PLC connected to the server SRV and wirelessly connected to a smart watch FB_D worn by the operator.

The smart watch FB_D can present a text label TL to the operator to indicate an anomaly, e.g. “CW wrinkle@R15,5” indicating a chord-wise wrinkle detected at a span-wise location 15,5 m from a reference point. The user can then provide a feedback via the PLC and back to the server SRV which can provide the feedback to a learning algorithm to improve detection and classification of anomalies accordingly.

The visual monitor V_M can be used to present a photo of the setup with an indication of the detected anomaly and its type. E.g. the visual monitor V_M can be a display on a tablet, a smart phone, or a large display or a computer monitor or the like.

FIG. 4 shows an example of an output to the operator to be presented in a display, e.g. a photo (indicated by the dashed line) of the surface of a part of the surface of the wind turbine blade part BL with an overlay text message. In FIG. 4 only a sketch of the blade part BL is shown for simplicity rather than a photo.

In this example, a wrinkle is indicated on the photo with a black dashed box and the related text “Wri 1 54%” indicates that the anomaly detected is a wrinkle, and that the system has calculated that the wrinkle is detected with a confidence of 54%.

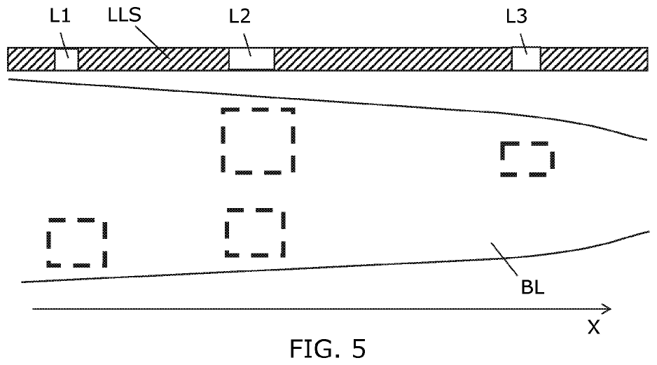

FIG. 5 shows another example of an output to the operator, namely a line of light indicators LLS setup span-wise along the wind turbine blade part BL, here indicated with a sketch. The light sources, e.g. LEDs, are controlled to indicate span-wise location of an anomaly. For example, all light sources can be green or be switched off, at span-wise positions where all is normal, whereas an anomaly is indicated with a light or with a red light. In the shown example light indicators L1, L2, L3 indicate span-wise position where anomalies are detected, here indicated with dashed black boxes.

Such line of lights LLS will allow an operator to easily locate an area with an anomaly L1, L2, L3 and to move to that position for a manual inspection.

E.g. the user interface may only indicate a detected anomaly by the light indicators LLS, and the operator can then move to search for an anomaly based on this information. In other variants, additional information is provided via the user interface to the operator, e.g. via a mobile terminal, a display on a wall or the like. This additional information may indicate a type of the detected anomaly to the operator.

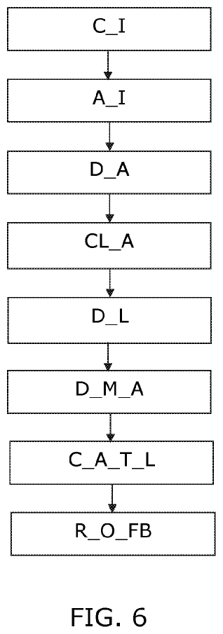

FIG. 6 illustrates steps of an embodiment for a method for manufacturing a wind turbine blade part, such as a blade half or a segment for a blade half, such as a composite fibre wind turbine blade part. The method comprises capturing images C_I of an area of manufacturing the wind turbine blade part, such as capturing images covering an entire area of the wind turbine blade part. Further, the method comprises analyzing A_I the captured images at least with respect to texture and/or contrast, such as analysing texture and/or contrast in a plurality of segments of the captured images.

Further, detecting D_A an anomaly on a part of the wind turbine blade part during the manufacturing process according to the analysis of the texture of the captured images. Further, classifying C_A the anomaly as one of a plurality of predetermined types of anomalies according to the analysis of the texture and/or contrast of the captured images. Further, determining D_L a localization of a classified anomaly on the wind turbine blade part, at least with respect to a first axis, such as with respect to both span-wise and chord-wise location. Further, comprising detecting D_M_A a manufacturing activity or manufacturing state in response to an analysis of the captured images. This may be performed to adapt at least one of or all of the algorithms behind the described steps A_I, D_A, CL_A. Further, the step D_M_A may further or alternatively be performed to adapt parameters of the image capturing C_I step, e.g. camera resolution, frame rate etc.

Finally, communicating C_A_T_L an anomaly type and a localization on the wind turbine blade part of the detected anomaly in real-time to an operator of the manufacturing process, thereby allowing the operator to initiate an action in the manufacturing process to remedy the detected anomaly. The method comprises receiving R_O_FB a feedback to the processor system from the operator in response to the communicated anomaly, thereby allowing training a neural network involved in at least detecting or classifying the anomaly in response to the feedback from the operator, so as to improve the detection and classification of anomalies.

To sum up, the invention provides a manufacturing system for a process of manufacturing a wind turbine blade part, such as a blade half or a segment for a blade half, e.g. a composite fibre wind turbine blade. An imaging system with cameras (CM) arranged at an elevated position to capture images of an area of manufacturing (A_M). A processor system (PS) is arranged to process (IA) captured images from the imaging system to analyze the captured images at least with respect to texture and/or contrast. Based on the image analysis, to detect (AD) an anomaly on a part of the wind turbine blade during the manufacturing process, to classify (ACL) the anomaly as one of a plurality of predetermined types of anomalies according to the analysis of the texture, and to further determine (AL) localization of the classified anomaly on the wind turbine blade, e.g. both span-wise and chord-wise position. A user interface is connected to the processor system to communicate an anomaly type and a localization on the wind turbine blade part in real-time to an operator of the manufacturing process.

Although the present invention has been described in connection with the specified embodiments, it should not be construed as being in any way limited to the presented examples. The scope of the present invention is to be interpreted in the light of the accompanying claim set. In the context of the claims, the terms “including” or “includes” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A manufacturing system for a process of manufacturing a wind turbine blade part, such as a blade half or a segment for a blade half, such as a composite fibre wind turbine blade part, the system comprising
an imaging system comprising at least one camera and being arranged to capture images of an area of manufacturing the wind turbine blade part, such as being arranged to capture images covering an entire area of the wind turbine blade part,
a processor system arranged
to process captured images from the imaging system to analyze the captured images at least with respect to texture and/or contrast,
to detect an anomaly on a part of the wind turbine blade during the manufacturing process according to the analysis of the texture of the captured images based on an anomaly detection algorithm,
to classify the anomaly as one of a plurality of predetermined types of anomalies according to the analysis of the texture and/or contrast of the captured images based on an anomaly classification algorithm, and
to determine (AL) a localization of a classified anomaly on the wind turbine blade, at least with respect to a first axis such as with respect to two axes and
a user interface operatively connected to the processor system, wherein the user interface is arranged to communicate an anomaly type and/or a localization on the wind turbine blade part of the detected anomaly in real-time to an operator of the manufacturing process, wherein
wherein the processor system is arranged to automatically detect a manufacturing activity or manufacturing state in response to an analysis of captured images from the imaging system, such as arranged to automatically detect a current manufacturing activity or manufacturing state based on selecting one of a plurality of predefined manufacturing activities or manufacturing states is the current, such as one of at least 6 predefined manufacturing activities or manufacturing states, such as selecting one of: 1) mould-preparation,

2) gelcoat-application, 3) outer-layup, 4) core-panels, 5) inner-layup, 6) vacuum-bagging, 7) resin infusion, 8) shell-cure-blanket, 9) debagging, 10) inspection-bond-preparation, 11) adhesive-cure, and 12) demould.

2. The manufacturing system according to claim 1, wherein the processor system is arranged to select an anomaly detection algorithm and/or an anomaly classification algorithm in response to a detected manufacturing activity or manufacturing state.

3. The manufacturing system according to claim 1, wherein the processor system is arranged to cause the imaging system to adapt its image capturing with respect to at least one parameter, such as image resolution and/or image capturing frequency, in response to a detected manufacturing activity or manufacturing state.

4. The manufacturing system according to claim 1, wherein the processor system is arranged to classify an anomaly as one of: 1) a wrinkle in a sheet or ply layup, 2) an aeration or a dry spot in laminate post-infusion, 3) a deviation from a spar cap centerline and adhesive, 4) wrinkles in a vacuum bag and/or foil, 5) air bubbles in a vacuum bag during infusion, 6) positioning deviations from design specifications of components of the wind turbine blade part, such as web locators, webs, lightning protection system cabling and fixtures.

5. The manufacturing system according to claim 1, wherein the user interface is arranged to receive a feedback from the operator to a detected anomaly, such as a feedback indicating a relevance of the detected anomaly, and wherein the user interface is arranged to communicate the feedback to the processor system.

6. The manufacturing system according to claim 5, wherein the processor system is arranged to receive the feedback in response to a detected anomaly and to process the feedback according to a learning algorithm serving to improve an accuracy of the anomaly detection algorithm and/or the anomaly classification algorithm in response to the feedback, such as the learning algorithm involving a neural network, such as a convolution neural network and/or a recurring neural network.

7. The manufacturing system according to claim 1, wherein the processor system is arranged to determine the localization of the classified anomaly on the wind turbine blade part, with respect to a longitudinal axis along the wind turbine blade part, such as span-wise, and with respect to an axis perpendicular to the longitudinal axis, such as chord-wise.

8. The manufacturing system according to claim 1, wherein the user interface comprises a display, such as a display on a portable device such as a tablet or a smart phone or a smart watch, and wherein an anomaly type and a localization on the wind turbine blade part of a detected anomaly is communicated by a symbolic and/or text overlay on a captured photo of the wind turbine blade part.

9. The manufacturing system according to claim 1, wherein the user interface comprises a projection system, such as a laser projector, such as a plurality of projectors arrange span-wise along the wind turbine blade part, arranged to provide a visual indication of a detected anomaly on the determined location directly on a surface of the wind turbine blade part.

10. The manufacturing system according to claim 1, wherein the user interface comprises a controllable line of a plurality of visual indicators, such as a plurality of LED light indicators arranged on a line, arranged along the wind turbine blade part to provide a visual indication of a longitudinal location of a detected anomaly.

11. The manufacturing system according to claim 1, preceding claims, wherein the manufacturing system is arranged to perform an automatic resin infusion tracking in response to the captured images during a resin infusion process activity on the wind turbine blade part, such as the automatic resin infusion tracking involves performing an analysis of infusion fill percentage over time during the resin infusion process activity.

12. The manufacturing system according to claim 11, wherein the processor system is operatively connected to control a resin infusion valve, such as to control the resin infusion valve to close in response to the automatic resin infusion tracking, such as to control the resin infusion valve to close in response to shell infusion being estimated to have reached 100% or almost 100%.

13. The manufacturing system according to claim 1, wherein the imaging system comprises at least one camera positioned and configured to provide images of an entire width of the wind turbine blade part, such as the at least one camera being positioned at a fixed height above a surface of the wind turbine blade part being a factor of 0.8-2.0 times a width of the wind turbine blade part.

14. A method of manufacturing a wind turbine blade part, such as a blade half or a segment for a blade half, such as a composite fibre wind turbine blade part, the method comprising:
capturing images of an area of manufacturing the wind turbine blade part, such as capturing images covering an entire area of the wind turbine blade part,
analyzing the captured images at least with respect to texture and/or contrast, such as analysing texture and/or contrast in a plurality of segments of the captured images,
detecting an anomaly on a part of the wind turbine blade part during the manufacturing process according to the analysis of the texture of the captured images,
classifying the anomaly as one of a plurality of predetermined types of anomalies according to the analysis of the texture and/or contrast of the captured images,
determining a localization of a classified anomaly on the wind turbine blade part, at least with respect to a first axis, such as with respect to two axes, and
communicating an anomaly and a localization on the wind turbine blade part of a detected anomaly in real-time to an operator of the manufacturing process.

15. A computer program product comprising a computer readable medium containing instructions which, when executed by one or more processors independently or collectively, performs an operation of manufacturing a wind turbine blade part, the operation comprising:
capturing images of an area of manufacturing the wind turbine blade part;
analyzing the captured images at least with respect to texture and/or contrast;
detecting an anomaly on a part of the wind turbine blade part during the manufacturing process according to the analysis of the texture of the captured images;
classifying the anomaly as one of a plurality of predetermined types of anomalies according to the analysis of the texture and/or contrast of the captured images;
determining a localization of a classified anomaly on the wind turbine blade part, at least with respect to a first axis, such as with respect to two axes; and
communicating an anomaly and a localization on the wind turbine blade part of a detected anomaly in real-time to a manufacturing process interface.

16. The computer program product of claim 15, wherein analyzing the captured images comprises analyzing at least one of either texture and/or contrast in a plurality of segments of the captured images.
